(19) United States
(12) Patent Application Publication
(10) Pub. No.: US 2026/0305656 A1
(43) Pub. Date: Oct. 8, 2026

(54) FLAVORING MECHANISM FOR STEAM OVEN

(71) Applicant: Raja Singh Tuli, Montreal (CA)

(72) Inventor: Raja Singh Tuli, Montreal (CA)

(21) Appl. No.: 19/635,863

(22) Filed: Apr. 1, 2026

Related U.S. Application Data
(60) Provisional application No. 63/783,267, filed on Apr. 4, 2025.

(51) Int. Cl. A23L 5/10; A23L 27/00; A23P 20/10; A47J 27/04; A47J 36/32; B65D 65/46; B65D 81/34

(52) U.S. Cl. CPC A23L 5/13; A23L 5/15; A23L 27/79; A23P 20/10; A47J 27/04; A47J 36/32; B65D 65/466; B65D 81/3438; A47J 2027/043; B65D 2581/3428

(57) ABSTRACT

The present invention relates to a method and apparatus for cooking food items, such as meats and vegetables, in a more efficient and faster manner while maintaining high product yield. The invention utilizes steam cooking in a stepped process, which allows for even cooking and browning in a single cycle. The cooking apparatus includes a flavoring mechanism that enables steam or compressed air to pass through flavor pods containing seasonings such as oils, salts, and spices. This flavored steam circulates within the cooking chamber, infusing the food with the desired flavors. In one embodiment, flavor pods positioned above the food release seasoning at specific times or temperatures, allowing for optimal flavoring before the final cooking stage. Another embodiment includes a film wrapped around the food that disintegrates at a predetermined temperature, releasing seasoning onto the food at the ideal cooking stage. These features ensure efficient and precise flavor infusion during cooking.

### CROSS-REFERENCE TO RELATED APPLICATIONS

This application claims priority to U.S. provisional patent application No. 63/783,267, entitled “FLAVORING MECHANISM FOR STEAM OVEN,” filed on Apr. 4, 2025. The content of this U.S. provisional patent application is hereby incorporated by reference in its entirety for all purposes.

### BACKGROUND OF THE INVENTION

### Field of the Invention

The present disclosure generally relates to the field of cooking foodstuffs such as meats and vegetables, in a faster, more efficient manner. More particularly, the invention relates to a method and apparatus for providing different types of flavor pods while cooking the foodstuff in a pressurized steam oven with the foodstuff being steam cooked in a first stage and seared in a second stage. The invention also relates to the technical field of cooking appliances, in particular to a flavor pods control method and device in a steam oven, cooking equipment, and all-in-one searing steam cooking machine etc.

### Description of Related Art

Intelligent household appliances, such as steaming and baking ovens, have made life more convenient by providing a range of facilities. However, these appliances often have different settings for different brands and models, making it difficult for users without experience to correctly set the heating mode, temperature, and time for a particular food material. Even those with some experience may find it challenging to adjust the settings for different types of food. To produce delicious meals, it is important for users to understand the various heating modes, temperatures, and times for their specific oven and the food they are cooking. However, this can be complicated, particularly for those with limited cooking experience. If the parameters are set incorrectly, it can result in undercooked or overcooked food that must be discarded, leading to wasted food and energy. Improperly cooked food can also be a safety hazard, as undercooked food may contain harmful bacteria while overcooked food may be burnt and potentially cause injury. It is important for users to carefully set the appropriate parameters and monitor the cooking process to ensure that their food is cooked safely and properly.

While some ovens claim to determine if the food is cooked properly, the determination is purely based on the outer surface of the food. This can lead to inaccurate judgment, resulting in a poor user experience. For example, the surface of the food may appear to be cooked, but the inner part may still be raw. This can be a safety hazard, as undercooked food may contain harmful bacteria, and it can also be frustrating for the user who may have to discard the food and start over. To ensure that food is cooked properly, it is important for the oven to be able to identify the food material, and accurately assess the internal temperature of the food while cooking, not just the surface.

In the past, methods and devices have used compressed air (both preheated and not) to achieve browning and surface texture on cooked meat and have tried to control the relative humidity within an oven or pressure vessel. However, these known pressure cooking processes that use high-pressure steam tend to produce meat that looks and tastes boiled rather than roasted. This can be undesirable for those who prefer the taste and appearance of roasted meat. To achieve a roasted flavor and texture, it may be necessary to use additional cooking methods or techniques once high-pressure steam cooking step is complete.

To improve the taste of cooked food, various methods have been proposed in the past. One example is a steam oven described in U.S. Pat. No. 9,854,931B2, which uses steam, including superheated steam, for cooking. This apparatus includes a flavoring container with a lid that has nozzles for allowing reheated steam to enter and exit, enhancing the food's flavor. The lids of the food and flavoring containers can be opened simultaneously, and the food container has a perforated floor to keep the food separated, along with an RFID tag at the bottom that holds cooking information. However, the complex design may make it difficult to maintain and clean the nozzle system, especially with multiple nozzles penetrating the foil, leading to potential clogging and sanitation issues.

Another such system was described in EP3118527A1, which outlines a method and apparatus for cooking and flavoring food using a steam generator in a cooking appliance. In this system, steam is introduced into an aroma unit, allowing the food to absorb flavoring agents before moving into the cooking chamber. However, the complex design of the aroma unit and steam pathways may require specialized components, such as multiple steam inlet nozzles, which could lead to higher maintenance needs for the appliance.

There is accordingly a need for an improved cooking apparatus and cooking process by providing more precise and evenly distributed heat and flavoring mechanism, as well as better control over the cooking environment.

It is therefore an object of the present invention to provide a cooking apparatus for cooking and flavoring the foodstuffs such as meats and vegetables, in a faster, more efficient manner by producing a mixture of compressed air and superheated steam. Further, the invention relates to a method and apparatus for cooking the foodstuff in a pressurized steam oven cavity with the foodstuff being steam cooked in stages and flavoring the food in between the cooking stages.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The invention relates to cooking foodstuffs such as meats and vegetables, in a faster, more efficient manner. More particularly, the present invention provides a cooking apparatus for cooking and flavoring the foodstuffs such as meats and vegetables, in a faster, more efficient manner by producing a mixture of compressed air and superheated steam. Further, the invention relates to a method and apparatus for cooking the foodstuff in a pressurized steam oven cavity with the foodstuff being steam cooked in stages and flavoring the food in between the cooking stages. Additionally, the invention can help in cooking, flavoring and browning food items evenly in a single cycle.

In a preferred embodiment, the cooking apparatus includes a flavoring mechanism that allows steam to travel through a flavor pod containing seasonings such as clove, basil oregano etc. As the steam circulates through the cooking chamber, it infuses the food with the seasoning flavors, enhancing its taste. The apparatus is equipped with a flavor pod holder designed to accept pods containing oils, salts, or other seasonings. The steam or compressed air passes through the flavor pods and carries the infused vapor into the cooking chamber, ensuring the food is evenly flavored during the cooking process. The steam nozzle is strategically placed to ensure maximum infusion.

In an alternate embodiment, the flavor pods are positioned above the food and can release seasoning either by temperature or time-controlled method. The pods may open when the food reaches a specific temperature, allowing the contents, such as oils, sauces or seasoning, to spill onto the food before it undergoes the final cooking stage, like searing. Another variation involves a dissolvable film that wraps the food and disintegrates at a specific temperature, releasing seasonings at the optimal time for enhanced flavor. These mechanisms ensure precise flavor infusion during cooking.

These and other features and advantages will be apparent from a reading of the following detailed description and a review of the appended drawings. It is to be understood that the foregoing summary, the following detailed description and the appended drawings are explanatory only and are not restrictive of various aspects as claimed.

### BRIEF DESCRIPTION OF THE DRAWINGS

FIG. 1A is a perspective front view of an example cooking apparatus in accordance with the subject disclosure.

FIG. 1B is a perspective side view of an example cooking apparatus in accordance with the subject disclosure.

FIG. 2 illustrates a flavoring mechanism in accordance with one embodiment of the disclosure.

FIG. 3 illustrates a flavoring mechanism in accordance with another embodiment of the disclosure.

FIG. 4 illustrates a flavoring mechanism in accordance with another embodiment of the disclosure.

### DETAILED DESCRIPTION

The subject disclosure is directed to cooking foodstuffs such as meats and vegetables, in a faster, more efficient manner. More particularly, the invention also relates to a flavor pods control method and device in a steam oven, cooking equipment, and all-in-one searing steam cooking machine etc.

The detailed description provided below in connection with the appended drawings is intended as a description of examples and is not intended to represent the only forms in which the present examples can be constructed or utilized. The description sets forth functions of the examples and sequences of steps for constructing and operating the examples. However, the same or equivalent functions and sequences can be accomplished by different examples.

References to “one embodiment,” “an embodiment,” “an example embodiment,” “one implementation,” “an implementation,” “one example,” “an example” and the like, indicate that the described embodiment, implementation or example can include a particular feature, structure or characteristic, but every embodiment, implementation or example can not necessarily include the particular feature, structure or characteristic. Moreover, such phrases are not necessarily referring to the same embodiment, implementation or example. Further, when a particular feature, structure or characteristic is described in connection with an embodiment, implementation or example, it is to be appreciated that such feature, structure or characteristic can be implemented in connection with other embodiments, implementations or examples whether or not explicitly described.

Numerous specific details are set forth in order to provide a thorough understanding of one or more embodiments of the described subject matter. It is to be appreciated, however, that such embodiments can be practiced without these specific details.

Various features of the subject disclosure are now described in more detail with reference to the drawings, wherein like numerals generally refer to like or corresponding elements throughout. The drawings and detailed description are not intended to limit the claimed subject matter to the particular form described. Rather, the intention is to cover all modifications, equivalents and alternatives falling within the spirit and scope of the claimed subject matter.

In the preferred embodiment of the invention, the foodstuff comprises foods items such as meat (e.g., bacon, pork chops, sausage, hamburger patties), poultry (e.g., whole turkey, chicken breasts or wings), seafood, vegetables (e.g., French fries, peppers), convenience or snack foods (e.g., burritos), pizza, breads, cookies, and pastries. It should be understood to one having ordinary skill in the art that foodstuff can comprise any variations of the above-mentioned food items marinated or lathered in oil or other substances.

Reverse searing is a two-step cooking technique that involves cooking a foodstuff slowly at a low temperature in the first step, and then searing it at a high temperature for a short period of time at the end of the cooking process in the second step. The result is a piece of foodstuff that is evenly cooked throughout and has a delicious, caramelized sear on the outside. However, the problem with the conventional reverse sear method of cooking foodstuff is that a user needs to take out the food from the oven and check the food item with a thermometer to measure the internal temperature while it is being slowly cooked at the first step. It is not easy for a person cooking the food to understand exactly when to stop the slow cook and start searing the food so that it is not overcooked. The foodstuff may not develop a proper sear or crust if the initial low temperature cooking is not done evenly or accurately. Foodstuff may be overcooked if the internal temperature reaches the critical temperature before foodstuff goes into the fast cooking or searing stage. Additionally, convection based methods heat the foodstuff from outside using high temperatures until the foodstuff is cooked from the inside. This may cause the juices in the foodstuff to evaporate and the foodstuff to become dry. So, it is important to monitor the cooking process closely and to adjust the temperature and cooking time as needed to ensure that the foodstuff is cooked to the desired level of doneness, i.e. juicy on the inside and crispy on the outside.

In some embodiments of the invention, the first cooking method can be any of the suitable methods but not limited to pressure cooking, roasting, baking, or sous vide. In a preferred embodiment, the first step cooking can be pressure steam cooking. Steam cooking and/or pressurized steam cooking can reduce the evaporation of juices from the foodstuff and also allow fast cooking at a lower temperatures due to higher conductivity of the steam. In some embodiments of the invention, the next step of reverse searing process can be any of the suitable methods but not limited to pan searing, grill searing, broiler searing or convection for cooking (searing) the foodstuff at very high temperature and to create a caramelized crust on the outside. In a preferred embodiment of the present invention, the second cooking method is convection based searing method using hot air to cook the foodstuff from the outside. In another embodiment, the second cooking method may use infra-red lamp to sear the foodstuff. The searing can be performed lesser amount of time to avoid overcooking the food.

In some embodiments of the invention, more than two stages and more than two cooking methods can be used for cooking the foodstuff in the oven. It should also be understood that the multiple cooking steps can be performed in any suitable order without deviating from the scope of the proposed invention. In some embodiments of the invention, the first cooking method can be searing of the foodstuff and the second cooking method can be slow steam cooking of the foodstuff. In this case, the time and parameters of the searing step can be adjusted based on the time and parameters of the slow cooking step so that the critical temperature of the foodstuff is reached after the second stage slow cooking.

The critical temperature for a food item refers to the temperature at which the food is considered to be cooked or safe to eat. The critical temperature for a food item depends on the type of food and the desired level of doneness. For example, the critical temperature for meat, such as chicken or beef, is typically around 165 degrees Fahrenheit (74 degrees Celsius). At this temperature, the meat is considered to be fully cooked and safe to eat. The critical temperature for other types of food, such as vegetables, grains, and fish, may be different.

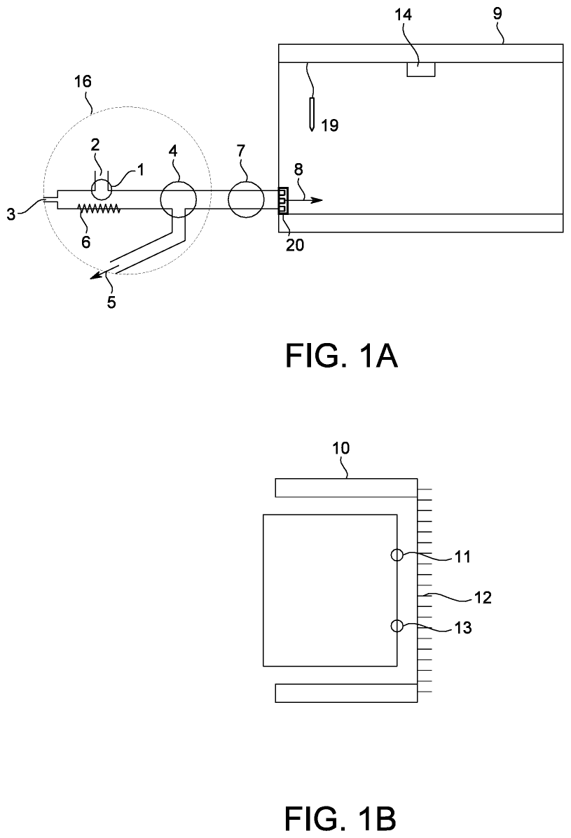

In FIG. 1A illustrates a cooking apparatus 10 for cooking food items in a stepped manner, in accordance with the embodiments of the present disclosure. The cooking apparatus 10 comprises a chamber 15 to place the foodstuff to be cooked. According to an embodiment of the invention, pressurized steam or hot air can be injected into the cooking apparatus 10 and the pressure inside the chamber is regulated through an injector means 16. The injector means 16 includes a heating element 6, a water intake means 3 to intake a small amount of water, an air intake pipe 1 to intake air which is controlled by a computer-controlled valve 2, a computer-controlled mixer valve 4, and an inlet 5 for outside air. In a preferred embodiment of the invention, steam is generated outside of the chamber 15 and pumped inside the chamber 15 allowing to inject the steam at different temperatures based on requirements. Even very low temperature steam like moist air can be injected into the chamber.

In the preferred embodiment of the invention, water coming through the water inlet 3 falls on the heating element 6 in a small chamber and generates steam. The steam is then mixed with outside air provided through the air inlet 1 monitored by the computer controlled valve 2. The valve 2 intelligently decides the mixing ratio of steam and outside air to create an appropriate amount of humidity inside the cooking chamber 15 through a humidity control algorithm. The valve 2 can also control the temperature of the steam and air mix by regulating the inlet air through the air inlet means 1. A temperature and humidity sensor 17 regularly measures the temperature and humidity of the steam and provides the readings to the valve 2. In this way, the valve 2 regulates and helps in generating the steam and air mix with an appropriate temperature and humidity. The generated steam is injected into the cooking chamber through an inlet 8 by a pump 7. It should be understood that in some embodiments of the invention, the cooking chamber 15 can comprise a pressure sensor to monitor the pressure inside the chamber and a humidity sensor to monitor the humidity inside the chamber. The pump 7 can pump the steam at specific pressure and regulate the pressure inside the chamber 15 based on feedback provided by a pressure sensor disposed inside the chamber 15 to measure the pressure.

FIG. 1B illustrates another perspective view of the cooking apparatus 10. When there is too much pressure inside the chamber 15, a computer controlled valve 13 releases the steam and regulates the pressure inside the chamber. In a preferred embodiment of the invention, the valve 13 is provided at the back of the cooking apparatus 10 so that in the event of steam release due to the high pressure inside the chamber or due to any mechanical failure of the valve, the user does not get hurt. When the food stuff is being cooked inside the cooking chamber, it increases the humidity inside the cooking chamber by releasing moisture content into the chamber. In a preferred embodiment of the invention, the pressure and humidity sensors regularly monitor the pressure and humidity inside the chamber to account for the increased humidity from the juices released by the foodstuff being cooked. The humidity control algorithm controls the cooking apparatus and creates the required humidity and pressure inside the cooking chamber 15 by regulating the pump 7 and valve 13. The pump 7 lets more air into the chamber if there is not enough humidity inside the chamber. If the humidity or pressure is too high inside the chamber, the valve 13 releases the pressure.

In a preferred embodiment, the cooking apparatus has a shape of a rectangular box. As shown in FIGS. 1A and 1B, a steam relief area 9 in the form of a gap is provided at the top, bottom and behind the cooking apparatus 10 working as a heat exchanger. Fins 12 are provided on a big plate at the back of the chamber to work as a heat sink, condense the steam and release heat quickly and safely.

The arrangement of the steam relief area 9 allows the released steam to spread in a large area and exhaust at a low temperature. In a preferred embodiment of the invention, an insulation 18 is provided at the top and the bottom of the cooking apparatus 10 to protect the users from burns. This helps the cooking apparatus to release the steam quickly and switch from a first cooking mode to a second cooking mode. In another embodiment of the invention, an additional mechanical safety valve 11 is provided at the back of the cooking chamber. The safety valve 11 decompresses the chamber to reach the normal pressure in the event of pressure reaching above the critical pressure for avoiding any accidents.

In a preferred embodiment, as a foodstuff is placed inside the cooking chamber 15 of the cooking apparatus 10, the pressurized steam is introduced quickly into the cooking chamber through the injector means 16. The pressurized steam is injected into the cooking chamber for a period of time t1 determined by the method to pressure cook the food in the first stage such that appropriate pressure and temperature inside the chamber are attained very quickly. In a preferred embodiment of the invention, the pressure and steam moisture inside the cooking chamber are maintained for the time period. The temperature and humidity inside the cooking chamber is controlled by the temperature and humidity sensors provided inside the cooking chamber. The internal temperature of the food can be measured by any suitable temperature measuring device including but not limited to a thermometer or an infrared camera. The method stops the first stage cooking before the internal temperature reaches the critical temperature. The first stage cooking under pressure significantly reduces the overall cooking time. Before transitioning into the second stage of cooking i.e. searing, the pressure inside the cooking chamber should be released.

In an embodiment, the cooking apparatus 10 includes a thermometer 19 to continuously measure the temperature of the foodstuff cooking in the cooking chamber. The thermometer 19 can provide dynamic feedback to adjust temperature and pressure inside the cooking chamber in real-time. In some embodiments of the invention, the thermometer 19 can be adapted to be inserted into the foodstuff to be cooked by the cooking apparatus 10.

In a preferred embodiment of the invention, the cooking apparatus 10 also comprises a flavoring mechanism that may contain any suitable flavoring spices such as clove, basil, oregano etc. to add flavoring to the foot item being cooked in the cooking apparats 10. The steam generated by the steam generating means 16 can travel through the said flavoring mechanism. In an alternate embodiment, the water coming from pump 1 for generating the steam may travel through a flavoring mechanism to generate the flavored steam. As flavored steam is injected into the cooking chamber, the steam circulates around the foodstuff. With this method of steam marinating, foodstuff can be infused with a particular flavor of user choice.

In a preferred embodiment, the flavoring mechanism of the cooking apparatus 10 may have a flavor pod holder 20 configured to accept the flavor pod. The flavor pod may contain ingredients like oils, salts, or seasonings such as oregano, lime, clove, basil or spices. As steam passes through the flavor pod, the aroma and taste of these seasonings are transferred into the steam. The flavored steam is then directed through a steam pipe, which is connected to the cooking chamber 15, allowing the vapor to infuse the food item being cooked in the cooking chamber 15. The steam nozzle 7 and the flavoring pod holder 20 are positioned strategically, ensuring that steam flows through the flavor pod holder 20, releasing the enhanced vapor into the cooking chamber 15. In an alternate embodiment of the invention, the flavour pod holder 20 configured to accept the flavor pod can be provided outside of the cooking chamber 15. The flavour pod holder 20 is arranged in such a manner that the steam is infused with the flavours contained in the flavour pod before being injected to the cooking chamber 15.

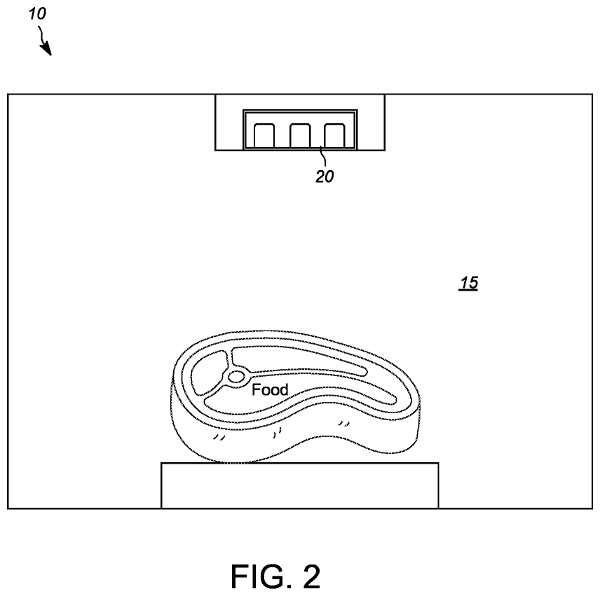

FIG. 2 further illustrates a cooking apparatus 10 in accordance with the embodiments of the present disclosure. The cooking apparatus 10 comprises a flavor pod holder 20 positioned above the food being cooked in the cooking chamber. The said flavor pod holder 20 may hold a pod allowing oil, salt, or other seasonings to be dispensed from above during the cooking process. In an alternate embodiment, flavor pod holder 20 provided on the ceiling can be provided as an additional pod holder to provide multiple flavors.

In a preferred embodiment, the flavoring pod holder 20 comprises a mechanism to create one or more small openings in the pod placed in side the pod holder 20. After the food placed inside the cooking chamber 15 is being cooked, a mechanical means in the pod holder 20 may puncher the flavoring pod to spread the pod contents over the food before the food is cooked (seared) in the next stage. The flavoring mechanism automatically creates small openings in the pod to dispense oil, sauce, seasonings etc. to spread onto the food. The dispensing of the contents of flavor pod can be controlled by time and/or temperature.

In an embodiment of the invention, a metallic pod containing oil, sauce, seasoning etc. can be designed to release the pod's contents at a specific temperature. For instance, after the food is cooked at 100 °C in the first stage and programmed to sear at 270 °C in the second stage, the pod may open at 200 °C, acting as a passive pod. In an alternate embodiment, the pods placed over the food in a pod dispenser may release the flavorings based on temperature changes, either through bimetallic or mechanical means.

In one or more embodiments, the one or more flavor pods comprise dry seasoning, liquid seasoning, aromatic herbs, spices, or a combination thereof.

In one or more embodiments, the control system adjusts the intensity and duration of seasoning infusion based on the type of food item, weight, cooking time, or user-selected preferences.

In one or more embodiments, the cooking apparatus includes multiple flavor pod holders, each configured to hold a different flavor pod, allowing selective infusion of different seasonings during different cooking stages.

In one or more embodiments, the seasoning infusion process is activated during a specific cooking phase, including searing, roasting, baking, slow cooking, or steaming, to enhance flavor absorption.

In one or more embodiments, the flavor pod is made from a biodegradable or heat-resistant material that allows controlled release of seasonings during the cooking process.

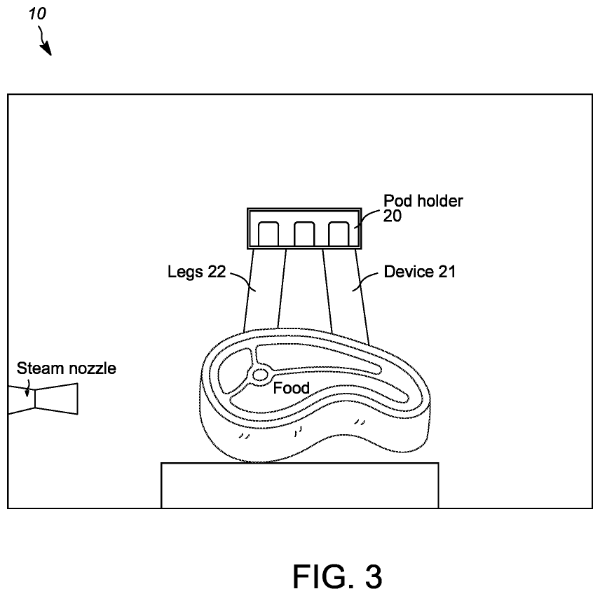

FIG. 3 illustrates a device 21 designed as a dispenser placed above the food. The device 21 may hold flavoring pod holder containing a flavoring pod. In an example embodiment, the device 21 may comprise four legs 22 that could embed in the food item being cooked inside the cooking chamber 15. The device 21 holds the flavor pod filled with the seasonings. The flavor pod releases contained seasonings onto the food at a specific temperature. In another embodiment, the flavor pods dissolves at specific temperatures to release seasonings onto the food. As the temperature of the food reaches to the desired temperature, the pod opens and spills the seasoning over the food. In an alternate embodiment, the opening of the pod can be controlled by a timer for precision.

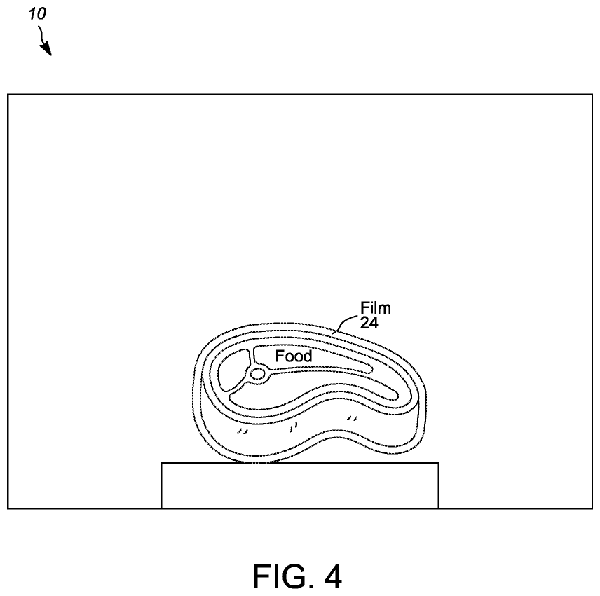

In another embodiment, a film 24 comprising seasoning, can be wrapped around food being cooked in the cooking chamber 15, as shown in FIG. 4. The seasoning is released at the optimal moment, enhancing the flavor during the final stages of cooking. The seasoned film is made with such a manner that it disintegrates at a temperature above the slow cooking temperature and below the searing temperature.

The specific processes or methods described herein can represent one or more of any number of processing strategies. As such, various operations illustrated and/or described can be performed in the sequence illustrated and/or described, in other sequences, in parallel, or omitted. Likewise, the order of the above-described processes can be changed. Although the subject matter has been described in language specific to structural features and/or methodological acts, it is to be understood that the subject matter defined in the appended claims is not necessarily limited to the specific features or acts described above. Rather, the specific features and acts described above are presented as example forms of implementing the claims.

What is claimed is:

1. A method for cooking and flavoring a food item in a cooking apparatus, the method comprising:
receiving the food item in a cooking chamber of the cooking apparatus;
providing one or more flavor pods, each containing at least one seasoning;
generating steam or using air or compressed air as a delivery mechanism to transport the seasoning from the flavor pods to the food;
passing the generated steam through a flavor pod holder containing the selected flavor pod, such that the steam is infused with the seasonings present in the flavor pod;
directing the flavored steam into the cooking chamber to circulate around the food item, thereby infusing the food item with the flavor of the seasoning;
controlling the delivery mechanism with a control system; wherein the control system activates the delivery mechanism during the cooking process based on predetermined cooking parameters.

2. The method of claim 1, wherein the one or more flavor pods comprise dry seasoning, liquid seasoning, aromatic herbs, spices, or a combination thereof.

3. The method of claim 1, wherein the control system adjusts the intensity and duration of seasoning infusion based on the type of food item, weight, cooking time, or user-selected preferences.

4. The method of claim 1, wherein the cooking apparatus includes multiple flavor pod holders, each configured to hold a different flavor pod, allowing selective infusion of different seasonings during different cooking stages.

5. The method of claim 1, wherein the seasoning infusion process is activated during a specific cooking phase, including searing, roasting, baking, slow cooking, or steaming, to enhance flavor absorption.

6. The method of claim 1, wherein the flavor pod is made from a biodegradable or heat-resistant material that allows controlled release of seasonings during the cooking process.

7. A system for dispensing seasonings onto food during cooking, comprising:
a cooking apparatus including a cooking chamber configured to receive a food item;
a flavor pod holder positioned above the food item inside the cooking chamber, configured to hold one or more flavor pods containing one or more seasonings;
a dispensing mechanism configured to create one or more openings in the flavor pod to release the seasoning from the flavour pods;
a control unit operatively connected to the dispensing mechanism, wherein the control unit is configured to regulate the timing and quantity of seasoning dispensed during the cooking process based on predetermined cooking parameters.

8. The system of claim 7, wherein after the food is steam-cooked, the flavor pod holder is configured to release seasonings over the food prior to a subsequent searing stage of cooking.

9. The system of claim 7, wherein the dispensing mechanism associated with each pod dispenser, wherein the dispensing mechanism is activated by temperature-responsive means.

10. The system of claim 7, wherein the dispensing mechanism includes a bimetallic element or a mechanical device that triggers the release of the seasoning when the cooking environment reaches a specific predetermined temperature, thereby dispensing the seasoning onto the food during cooking.

11. A system for dispensing seasonings onto food during cooking, comprising:
a cooking apparatus including a cooking chamber configured to receive a food item;
a flavor pod holder positioned above the food item inside the cooking chamber, configured to hold one or more flavor pods containing one or more seasonings; and
a dispensing mechanism configured to release the seasoning from the flavour pods.

12. The system of claim 11, wherein a dispensing device holds the flavour pod over the food.

13. The system of claim 12, wherein the dispensing device can comprise three legs.

14. The system of claim 12, wherein the dispensing device can comprise four legs.

15. The system of claim 11, wherein the dispensing mechanism includes a bimetallic element or a mechanical device that triggers the release of the seasoning when the cooking environment reaches a specific predetermined temperature, thereby dispensing the seasoning onto the food during cooking.

16. A method for dispensing seasoning onto a food item during cooking, the method comprising:
wrapping the food item in a film, wherein the film encloses at least one seasoning;
selecting a film material that disintegrates when exposed to a temperature between a predetermined slow-cook temperature and a predetermined searing temperature;
heating the food item in a cooking apparatus, wherein the film disintegrates when the cooking temperature exceeds the slow-cook temperature but remains below the searing temperature;
releasing the seasoning enclosed by the film onto the food as the film disintegrates during cooking.
